(19) United States
(12) Patent Application Publication
(10) Pub. No.: US 2025/0176580 A1
(43) Pub. Date: Jun. 5, 2025

(54) EDIBLE PRIMER LAYER

(71) Applicant: Sun Chemical Corporation, Parsippany, NJ (US)

(72) Inventors: Huijuan CHEN, Parsippany, NJ (US); Jeffrey KENNEDY, Amelia, OH (US)

(73) Assignee: Sun Chemical Corporation, Parsippany, NJ (US)

(21) Appl. No.: 18/843,903

(22) PCT Filed: Apr. 25, 2023
(86) PCT No.: PCT/US2023/019715

§ 371 Date: Sep. 4, 2024

Related U.S. Application Data
(60) Provisional application No. 63/340,621, filed on May 11, 2022.

(51) Int. Cl. A23G 1/30; A23G 1/54; A23G 3/34; A23G 3/54; A23L 29/10; A23L 29/25; A23P 20/10; A23P 20/25

(52) U.S. Cl. CPC A23G 1/305; A23G 1/54; A23G 3/0089; A23G 3/0097; A23G 3/343; A23G 3/54; A23L 29/10; A23L 29/25; A23P 20/105; A23P 2020/253

(57) ABSTRACT

The present application describes a primer formulation which is sugar-free and composed from food safe materials. The primer compositions contain two or more surfactants. The primer compositions do not contain a whitening or opacifying agent, and the primer surface dries as a transparent film. The primer composition forms an excellent receiving layer for edible inks.

### CROSS REFERENCE TO RELATED APPLICATIONS

The present application claims priority to U.S. Provisional Patent Appl. No. 63/340,621 filed May 11, 2022, which is hereby incorporated herein in its entirety.

### FIELD OF THE INVENTION

The present invention provides an edible water-based composition that can be applied to foodstuffs, such as confectionaries. The composition is useful as a primer coating for foodstuffs, enabling full color inkjet decoration of the foodstuff with edible dye or pigment inks.

### BACKGROUND OF THE INVENTION

Many food items are decorated with edible substances to make them more appealing, more festive, etc. In some instances, decorations can be used to aid in identification, e.g., to differentiate between two items that would otherwise look the same, but contain different materials, such as pies that are covered with the same pastry but contain different fillings. Confectioneries, e.g., sugar, flour or chocolate confections, are often decorated with images, characters, patterns, etc., created by the use of edible inks. A variety of inks and printing methods have been developed for this purpose, including inkjet printing methods and edible inkjet inks.

However, the images prepared by printing directly onto the foodstuffs are not always of good quality. On some surfaces, especially oil containing surfaces, the images may be blurred or uneven and may be too easily removed. Color images, such as those prepared using different color inks, may suffer from color bleeding or coalescence.

BE1012895 A6 discloses a process that uses screen printing to assemble a laminate structure on top of a chocolate foodstuff on which a color is formed by applying edible inks containing over 40% solids of pigment via screen printing. The printing process uses a plurality of printers, each printing a different color ink. The printers are arranged in a line and are separated from each other by a drying unit. After one color is applied, the ink is dried before the substrate moves to the next printer. However, acceptable images are not formed on all confectionery surfaces, in particular oil-containing surfaces.

US20070237869 A1 discloses that oil-containing foodstuffs, for example chocolate, are often difficult to decorate using edible inks, but coating the foodstuff with a white or opaque coating, comprising a powdery base selected from the group consisting of lactose, starch, calcium powder, and mixtures thereof, and a binder selected from the group consisting of powdered sugar, starch syrup, gelatin, and mixtures thereof, provides a print receptive layer for subsequent overprinting with edible inkjet inks. The coating also typically contains a white pigment, such as titanium dioxide, calcium carbonate powder, or powdered egg shell, and lecithin, serving as an emulsifier.

JP2013192557 discloses that the inkjet printing of images using water-based edible inks onto the surfaces of hydrophobic foods, oily foods, soaps, wax products, etc., is greatly improved by first applying a white, alcohol containing pretreatment liquid to the surface of the material to be printed. The pretreatment comprises a soluble natural polysaccharide, preferably a cellulose derivative, such as, hydroxypropylmethylcellulose or hydroxypropylcellulose, a food emulsifier, and a water and alcohol mixture. The alcohol is said to improve the drying property of the surface to which the pretreatment liquid is applied and reduces repelling of the pretreatment liquid when it adheres to the food. The water-soluble natural polysaccharide is a cellulose derivative, which effectively improves the wettability of the printed surface, eliminates bleeding and repelling of the printed ink.

JP6207910 B2 discloses another hydroxypropylmethylcellulose or hydroxypropylcellulose primer that can be applied to chocolate as a buffer layer for so-called pattern printing. The primer comprises a buffer selected from the group consisting of hydroxypropyl cellulose and hydroxypropylmethyl cellulose, and a water-soluble cellulose plasticizer selected from the group consisting of glycerin and propylene glycol.

U.S. Pat. No. 6,893,671 B2 Discloses a chocolate confectionery comprising a black or colored high resolution edible image, which is deposited on a white or light-colored, sugar-based image-substrate coating dispersed on a surface of the chocolate confectionery. Typically the chocolate is milk or dark chocolate and the image-substrate coating is substantially white or light colored, which provides for excellent image contrast when edible high resolution images are printed thereon using edible inks applied by ink jet printing. The substantially white or light colored edible image-substrate coating is comprised of at least one of a binding agent, a food grade white pigment, and a sugar or mixtures thereof. Typically, the binding agent is one or more starches, but other binding agents, such as cellulose, gum arabic, dextrin and the like, may also be present. One example of the image-substrate coating solution comprises: 100 g of a TiO2 dispersion in a saturated aqueous sucrose solution, 37 g of corn syrup, 32 g of water, 23 g of corn starch, 5 g of gum Arabic and 25 g of ethanol.

US20090186121 discloses an edible substrate enhancer that reduces the blurring, smearing or bleeding of an image printed onto an edible substrate. The substrate enhancer comprises a cellulose derivative, a silica, a dextrin, or a combination thereof, mixed or dissolved in a carrier, such as organic solvents (alcohols), liquids, fluids and dry carriers, sugars, or sugar substitutes. Less than 12% water is present. Upon application, the edible substrate enhancer dries to form granules on the surface of the substrate.

Other coatings for chocolate that are not for improving printed images, include US 20030157231 A, which discloses a sugar-based coating can be used to encapsulate chocolate, and US20090246330 A1, which discloses an anti-scuff coating to protect the surface of a chocolate.

Often, when using compositions such as those above, two or more applications of the same or different functional layers are required. Furthermore, these functional layers typically contain an opacifier (e.g. a whitener or white pigment) and/or colorant, and contain ingredients which when dry impart a white haze or opaque nature to materials such as to the chocolate. As shown above, many of these known compositions comprise sugar, alcohols, glycerols and other components that are best avoided when decorating foodstuffs.

Citation or identification of any document in this application is not an admission that such represents prior art to the present invention.

### BRIEF SUMMARY OF THE INVENTION

The present application provides an edible composition, useful as a primer on the surface of an edible substrate, to create a primer surface upon which edible inks can be deposited or printed to create full color decorations with enhanced image sharpness, and low color bleeding and low coalescence.

The composition of the invention comprises;
12-35 wt % one or more gums, based on the weight of the composition;
0.01 to 5 wt % in total, two or more surfactants, based on the weight of the composition, comprising at least a first surfactant and a second surfactant, wherein the first surfactant comprises mono- and di glycerides of one or more C₆-C₁₂ carboxylic acids; and 60 to 85 wt % water;
wherein the composition is free of any opacifying agents, and in many embodiments free of colorants, and dries to form a transparent film; and
wherein the composition is compliant with US FDA CFR Part 21 and Europe Regulation [EC 178/2002].

One or more than one gum may be used. Typically, the gum is selected from the group consisting of gum arabic, guar gum, xanthan gum, agar agar powder, chia seed powder, arrowroot powder, flaxseed powder, psyllium husk and blends thereof. In many embodiments the gum comprises gum arabic.

It is known that a surfactant may serve many functions in a composition, e.g., various surfactants have been employed as emulsifiers, wetting agents, detergents, foaming agents, or dispersants, and one surfactant may exhibit more than one of these functions. The composition of the present invention comprises two or more surfactants, which are chosen to ensure certain complimentary activities, i.e., wetting agent and emulsifier. The first surfactant, comprising mono-, di-, and typically triglycerides of one or more C₆-C₁₂ carboxylic acids, acts, at least in part, as a highly effective wetting agent. The second surfactant is selected to act, at least in part, as an emulsifier. In many embodiments, the second surfactant comprises a mixture of fatty acid esters of polyoxyethylene sorbitan, also known as polysorbates, and/or citric acid esters of mono-, di- and often triglycerides.

The absence of colorants, e.g., dyes or pigments, and opacifying agents allows the composition to dry to form a transparent layer without color.

Generally, the invention is effective without the presence of sugars, starches, modified starches such as maltodextrin, or any polysaccharides other than the one or more gum. And in many embodiments, no organic solvents, such as ethanol and other low boiling alcohols, are present. Polyols, such as glycols, including glycerol or monopropylene glycol, are not typically used, resulting in faster drying time for the coating, which makes the cycle time much shorter in food production.

If organic solvents are present, the concentrations of them are low, e.g., less than 10 wt %, often less than 5 wt %, and more typically less than 2 wt %. In instances where sugars, starches, modified starches, or polysaccharides other than the one or more gum are present, the concentrations will be very low, e.g., less than 2 wt %, typically less than 1 wt %.

In most embodiments however, sugars, starches, polysaccharides other than the one or more gum, and organic solvents are absent and the primer is sugar free, alcohol free and VOC free.

Also provided is a method for decorating a foodstuff and the decorated foodstuff obtained. The method comprises: applying the primer to a foodstuff, drying the primer layer, printing one or more colored edible inks over the top of the primer, and drying the one or more inks. The primer is readily applied via spray coating, nozzle coating, slot coating, inkjet printing, etc., There is no practical limitation to how the edible ink is applied, however, known printing technologies, such as inkjet printing, may be used.

Some embodiments comprise the further step of printing an overprint coating over the top of the inks. In some embodiments, the overprint coating is the same composition as the primer coating.

### DETAILED DESCRIPTION OF THE INVENTION

The present invention provides a water-based composition composed of food safe materials, useful as a primer layer for foodstuffs decorated with edible inks. The composition is a fast drying liquid that does not contain a whitening or opacifying agent and dries to form a transparent film upon which edible inks can be printed.

It is to be understood that the foregoing general description and the following detailed description are exemplary and explanatory only, and are not restrictive of any subject matter claimed.

Headings are used solely for organizational purposes, and are not intended to limit the invention in any way.

Unless otherwise defined, all technical and scientific terms used herein have the same meaning as is commonly understood by one of skill in the art to which the inventions belong. All patents, patent applications, published applications and publications, websites and other published materials referred to throughout the entire disclosure herein, unless noted otherwise, are incorporated by reference in their entirety for any purpose. Although any methods and materials similar or equivalent to those described herein can be used in the practice or testing of the present invention, the preferred methods are described.

### Definitions

In this application, the use of the singular includes the plural unless specifically stated otherwise. As used herein, the singular forms “a,” “an” and “the” are intended to include the plural forms as well, unless the context clearly indicates otherwise.

In this application, the use of “or” means “and/or” unless stated otherwise.

As used herein, the terms “comprises” and/or “comprising” specify the presence of the stated features, integers, steps, operations, elements, and/or components, but do not preclude the presence or addition of one or more other features, integers, steps, operations, elements, components, and/or groups thereof. Furthermore, to the extent that the terms “includes,” “having,” “has,” “with,” “composed,” “comprised” or variants thereof are used in either the detailed description or the claims, such terms are intended to be inclusive in a manner similar to the term “comprising.”

As used herein, “substrate” means any surface or object to which an ink or coating can be applied. In the present case, a substrate is typically a foodstuff, e.g., a confectionary.

As used herein “article” or “articles” refers to a substrate upon which an ink or coating has been applied, or a substrate upon which an ink or coating will be applied.

As used herein, the terms “inks and/or coatings,” “inks and coatings,” “inks or coatings,” “inks,” and “coatings” are used interchangeably.

As used herein, “sugars” refers to monosaccharides, e.g., glucose, galactose or fructose and the like, and “disaccharides”, e.g., sucrose, lactose and the like.

When used herein, “polysaccharide” refers to a compound comprising 3 or more saccharide units, and includes oligosaccharides, i.e., compounds comprising 3-10 saccharide units, and compounds with a higher number of saccharide units, such as, cellulose, glycogen, starches, including modified starches like maltodextrins, and gums.

As used herein “gum” refers to a non-starch, water soluble, complex polysaccharide containing several different sugar molecules and uronic acid groups.

Image sharpness refers to how clearly the printed image is generated.

Color bleeding refers to mixing of two dissimilar colors in two adjacent printed dots before they dry and absorb in substrate.

Coalescence refers to an image defect that occurs when wet ink drops touch one another on the receiver surface, combining into larger drops causing images to appear blotchy or ‘puddled’, resulting in non-uniformity in solid fill areas.

As used herein, the term “opacity” of an ink or coating refers to its ability to cover the color or color differences of a substrate. Opacity depends on the amount of light that is transmitted through, or reflected from, the surface of the ink. More opaque materials have a greater tendency to reflect and refract light.

As used herein, ranges and amounts can be expressed as “about” a particular value or range.” “About” is intended to also include the exact amount. Hence, “about 5 percent” means “about 5 percent” and also “5 percent.” “About” means within typical experimental error for the application or purpose intended. It is to be understood that wherein a numerical range is recited, it includes the end points, all values within that range, and all narrower ranges within that range, whether specifically recited or not.

Throughout this disclosure, all parts and percentages are by weight (wt % or mass % based on the total weight) and all temperatures are in ° C. unless otherwise indicated.

### Compositions and Uses Thereof

When used as a primer on decorated foodstuffs, the composition of the invention provides enhanced image sharpness, and low color bleeding and low coalescence.

One embodiment of the invention provides a primer composition suitable for coating a foodstuff, comprising:
about 12- to 35 wt %, about 12 to 30 wt %, or about 15 to 25 wt %, of one or more gums, based on the weight of the composition;
about 0.02 to 5 wt %, about 0.02 to about 3 wt %, or about 0.4 to about 2 wt % in total, of two or more surfactants in total, based on the weight of the composition, comprising at least a first and a second surfactant;
wherein the first surfactant comprises one or more C₆-C₁₂, C₆-C₁₀, or C₈-C₁₀ acid esters of glycerol, and the second surfactant comprises a different food safe surfactant; and
about 60 to 85 wt %, about 65 to about 85 wt %, or about 70 to 85 wt % water, based on the total weight of the composition;
wherein the primer composition is free of opacifying agents and dries to form a transparent layer; and
wherein the primer is compliant with US FDA CFR Part 21 and Europe Regulation [EC 178/2002].

The first surfactant comprises a single component or a blend of mono-, di- and triglycerides of C₆-C₁₂, C₆-C₁₀, or C₈-C₁₀ carboxylic acids, which performs as a wetting agent. In one embodiment, the first surfactant comprises a blend of mono-, di- and triglycerides of caprylic (C₈) and capric (C₁₀) acid derived from vegetable sources, one commercial example being Imwitor® 742 (IOI Oleochemical).

The second emulsifier is selected to act as an emulsifier and in many embodiments comprises polyoxyethylene sorbitan esters, and/or citric acid esters of mono- and diglycerides. A number of surfactants comprising polyoxyethylene sorbitan fatty acid esters, i.e., polysorbates, are well known and commercially available as Polysorbate 20, 40, 60 or 80, and derived from polyethoxylated sorbitan and predominately oleic acid. Other carboxylic acids may be used in making the polyoxyethylene sorbitan esters, but in many embodiments, the sorbitan esters will comprise longer chain fatty acids than those of the of mono-, di- and triglycerides of C₆-C₁₂, C₆-C₁₀, or C₈-C₁₀ carboxylic acids used in the first surfactant.

Citric acid esters of mono- and diglycerides are also commercially available, e.g., Citrem, purchased from International Flavors & Fragrances Inc.

More than one gum may be used. Typically, the gum is selected from the group consisting of gum arabic, guar gum, xanthan gum, agar agar powder, chia seed powder, arrowroot powder, flaxseed powder, psyllium husk and blends thereof. In many embodiments the gum comprises gum arabic.

The amount of gum in the present composition is higher than one typically encounters in decorative food compositions, such as primers for further ink decoration. In most embodiments, the primer contains little to no sugars, e.g., glucose, sucrose, fructose, lactose, etc., little to no starches or modified starches such as maltodextrins, or any polysaccharides other than the one or more gum. For example, if present, any sugars, starches, modified starches or other polysaccharides would be present at less than 2 wt %, based on the total weight of the composition. Typically, sugars, starches, modified starches and other polysaccharides are absent from the present composition.

Thus, whereas most primer layers for foodstuffs currently in use contain a sugar (classed as a sweetener in the food industry), in most embodiments, the composition of the present invention is essentially “sugar-free”.

The primer of the inventive primer composition also contains little to no organic solvent, e.g., less than 10 wt %, e.g., typically less than 5 wt % or less than 2 wt %, based on the total weight of the composition, and, many embodiments contain no organic solvent. Preferably, in the present invention, alcohols and glycols are generally absent from the composition as are all VOCs (Volatile Organic Compounds).

In preferred embodiments of the invention, the primers are sugar-free, alcohol-free and VOC-free.

The primer of the present invention can be successfully employed on almost any confection where decoration is desired, as well as other foodstuffs. In many embodiments, the foodstuff is a confectionary, and in a particular embodiment, a chocolate.

Chocolate presents a particular challenge for confectionary primer coatings of the art. For example, chocolate may suffer from “blooming”, which occurs when cocoa solids and oils or fats in the chocolate separate and rise to the surface. Confectionary primers typically contain a whitening or opacifying agent, which, when dried, leaves a light or white coating on the surface of the chocolate, which creates the impression of blooming. Also, as blooming can occur over time with, e.g., milk chocolates, consumers may associate it with aged or stale chocolates.

Often, confectionary primers of the art require two or more applications of the same or different functional layers, which has the potential to compound this problem.

The present invention solves the problems associated with the appearance of blooming in chocolate by providing a single liquid primer, that typically requires application of only one coating, and which dries to form a transparent layer. The functionality of the primer layer then enables subsequent decoration of the chocolate or other foodstuff with a set of edible, colored inks, to yield vibrant images with good print quality on the surface of the chocolate. In many embodiments, the primer would impart no taste to the chocolate and meets the regulatory standards for use on chocolate (and other) food articles.

In addition to the primer layer being easily over-printed with subsequent layers of edible inkjet inks in the formation of images, in some embodiments, a further coating of the primer layer applied over the surface of the printed image can serve as an overprint layer to protect the printed image against damage and/or add a glossiness or sheen to the image.

Preparation of a decorated foodstuff using the primer composition of the invention comprises:
a) applying the primer to a foodstuff;
b) drying the primer layer;
c) printing one or more colored edible inks over the top of the primer; and
d) drying the one or more inks.

The primer of the invention typically has a viscosity of from 5-100 cPs, measured on a Brookfield DV II+ Pro Viscometer, using a UL spindle at 30 rpm, where the sample cell is immersed in a temperature-controlled water bath at 25° C. Any suitable method can be used for applying the primer to the foodstuff, e.g., spray coating, nozzle coating, slot coating, inkjet printing, etc. For example, the primer can be applied using a simple trigger-head bottle. In most embodiments a single application of the composition as primer is sufficient. There is no practical limitation to how the edible ink is applied, however, in many embodiments inkjet printing is used. Any suitable method can be used in drying the layers.

Some embodiments also comprise the additional steps of:
e) printing an overprint coating over the top of the inks; and
f) drying the over print coating.

In some embodiments the overprint coating comprises a composition of the present invention, either the same as that used as the primer, or different from the primer, although in other embodiments there is no particular limitation on the composition of the overprint coating.

Any suitable foodstuff can be used in in the invention, including confections, other baked goods, fruits, vegetables, nuts, etc. For example, confections include:
flour confections, including cakes, tarts, pies, doughnuts, cookies, pastries, etc.,
chocolate confections, including chocolate-covered confections, chocolate-panned confections, chocolate bars, chocolate-covered fruits, nuts, and cremes, and the like,
other sugar confections, including candies, chewing gums jellies, nougats, fondants, caramels, toffees, etc.

In many embodiments the foodstuff is a chocolate material, which is white, milk or dark chocolate, or a combination thereof.

The printed primers generally exhibit surface tension in the range 20-40 dynes/cm. For non-absorbing, hydrophobic surfaces, such as chocolate, which has low surface energy, primer solution surface tension of 20-35 dynes/cm is preferred. The primer should be stable such that surface tension is consistent and maintained in the optimum level with aging.

The water-based composition of the invention is an effective primer for food decoration, and is highly effective at enabling the printing of edible inks onto foodstuffs, including confectionaries, and is especially effective for typically hard to decorate foodstuffs, such as chocolate or other oil containing surfaces. The primer formulation is made entirely from food safe materials. In one embodiment the ingredients would all be classified as meeting US FDA CFR Part 21 and Europe Regulation [EC 178/2002] regulations.

Advantageously, the primer can be used in small single printer shops, point-of-sale or large food production facilities.

The invention is further described by the following non-limiting examples which further illustrate the invention, and are not intended, nor should they be interpreted to, limit the scope of the invention.

### EXAMPLES

IMWITOR 742, from IOI Oleochemical, is a surfactant comprising mono-, di- and triglycerides of C₈ caprylic acid and C₁₀ capric acid derived from vegetable sources.

Polysorbate 80 from Croda's Specialty Chemicals and Performance Additives, is a surfactant comprising a mixture of fatty acid esters, primarily oleic acid esters, of polyoxyethylene sorbitan.

Citrem from International Flavor and Fragrance, Inc. is a surfactant comprising citric acid esters of mono- and diglycerides.

### Surface Tension

Surface tensions of the primer solutions were measured using Aqua Pi Plus tensiometer by Kibron Inc. Surface tension is reported as dynes/cm.

### Color

Color is measured using an i1 spectrometer from X-Rite Corporation.

Method of Coating Chocolate with Primer

Commercially available chocolates such as Lindt & Cadbury white and milk chocolate were used in the experiment. The chocolate surfaces were coated with primer using spray method with a CENTRAL PNEUMATIC 4 Oz. Adjustable Detail Air Spray Gun, with 0.6 mm application nozzle size. 25 gram of each of the primer compositions prepared as described below (both control and inventive) were added respectively to the sprayer reservoir. An air regulator was connected to the spray bottle and set to 35 psi for optimal spray pattern. The spray was done in lateral overlapping passes to achieve ˜260 gram per square meter wet coverage. The sample was allowed to air dry overnight.

### Coating Quality Assessment

Coated chocolate surfaces were visually evaluated and ranked in the following categories on a scale of 1-5, with 4 and 5 considered a pass, and 1-3 considered a fail.
1) Severe defect, significant area of non-uniform coverage, or cracking
2) Some defect, large area of non-uniform coverage
3) Noticeable defect, non-uniform coverage
4) Slight defect (e.g. bubbles, slight coating defect)
5) Surface smooth and consistent, no obvious defect

### Method of Printing on Chocolate

A LogoJet FSR30 printer with a height adjustable flatbed was used to print with edible Sensijet FSE inks composed of cyan, magenta, yellow and black edible inks. Chocolate samples were loaded on the flatbed machine and test targets containing red, green, and blue color blocks and letters were printed at 720×900 dpi resolution. The printed samples were allowed to air-dry at room temperature for 24 hours before image quality assessment.

### Image Quality Assessment

Printed Chocolate samples were visually evaluated and ranked in the following categories on a scale of 1-5, with 4 and 5 considered a pass, and 1-3 considered a fail. Image sharpness, color bleeding and coalescence. Image sharpness is defined as how clearly the printed image is generated. Color bleeding means mixing of two dissimilar colors in two adjacent printed dots before they dry and absorb in substrate. Coalescence in printing is an image defect that occurs when wet ink drops touch one another on the receiver surface, combining into larger drops. This causes images to appear blotchy or ‘puddled’, resulting in non-uniformity in solid fill areas.
1) Very bad coalescence & color bleeding, poor image sharpness
2) Very obvious coalescence and color bleeding, many image sharpness defects
3) Some coalescence and color bleed, some image sharpness defects
4) Slight coalescence and color bleed, slight image sharpness defects
5) No apparent coalescence, no color bleed, good image sharpness

### Examples 1-4: Preparation of Primer Compositions

Primers were prepared according to the following descriptions and summarized in Table 1.

### Example 1. Primer (Inventive)

0.16 gram Imwitor 742, 46.08 g Gum Arabic Stock solution (37.2% Solid), and 1.4 gram Polysorbate 80 were mixed with 33.64 gram of distilled water. The mixture was stirred on a laboratory stir plate for 1 hour at room temperature. The resultant composition contains 0.2% Imwitor 742, 1.4% Polysorbate 80, 21% Gum Arabic and 77.4% distilled water.

### Example 2. Primer (Inventive Example Using a Different Second Surfactant than Example 1)

0.16 gram Imwitor 742, 46.08 g Gum Arabic Stock solution (37.2% Solid), and 0.016 gram Citrem were mixed with 33.74 gram of distilled water. The mixture was stirred on a laboratory stir plate for 1 hour at room temperature. The resultant composition contains 0.2% Imwitor 742, 0.02% Citrem, 21% Gum Arabic and 78.8% distilled water.

### Example 3. Primer (Comparative-Contains No Imwitor 742)

46.08 gram Gum Arabic Stock solution (37.2% Solid), and 1.4 gram Polysorbate 80 were mixed with 33.80 gram of distilled water. The mixture was stirred on a laboratory stir plate for 1 hour at room temperature. The resultant composition contains 1.4% Polysorbate 80, 21% Gum Arabic and 77.6% distilled water.

### Example 4. Primer (Comparative-Contains No Second Surfactant)

0.16 gram Imwitor 742, and 46.08 gram Gum Arabic Stock solution (37.2% Solid) were mixed with 33.76 gram of distilled water. The mixture was stirred on a laboratory stir plate for 1 hour at room temperature. The resultant composition contains 0.2% Imwitor 742, 21% Gum Arabic and 78.8% distilled water.

TABLE 1
Primer Compositions

| | | Description | | | |
|---|---|---|---|---|---|
| Type | ID | Surfactant(s) | | | Gum |
| Inventive | Ex 1 | 0.2% Imwitor742 | plus | 1.40% Polysorbate 80 | 21% Gum Arabic |
| Inventive | Ex 2 | 0.2% Imwitor742, | plus | 0.02% Citrem, | 21% Gum Arabic |
| Comp. | Ex 3 | — | | 1.40% Polysorbate 80 | 21% Gum Arabic |
| Comp. | Ex 4 | 0.2% Imwitor742 | | — | 21% Gum Arabic |

Imwitor ® 742 (IOI Oleochemical), fatty acid ester of mono-, di- and triglycerides.
Citrem, citric acid esters of mono-and diglycerides.

### Whitening Effect

Typical confectionary primers dry to a white or opaque appearance, which can be mistaken for chocolate aging. The whitening effect is evaluated by coating a Leneta Company Opacity Form 5C card with the primers and measuring the color using an i1 spectrometer from X-Rite Corporation.

The primers were applied using a spray method with a CENTRAL PNEUMATIC 4 Oz. Adjustable Detail Air Spray Gun, with 0.6 mm application nozzle size with an air regulator connected to the spray bottle and set to 35 psi for optimal spray pattern as described above for the “Method of Coating Chocolate with Primer”.

Color value L, a, b of the uncoated black area (1) and coated area black area (2) were measured, and Delta E was calculated. A Delta E<2 was considered a minimal or non-detectable difference to the human eye and thus acceptable for whitening effect. Alternately, a Delta E<4 is considered acceptable for certain end-use applications.

TABLE 2
Whitening Effect

| | Uncoated | | | Coated | | | Delta |
|---|---|---|---|---|---|---|---|
| ID | L | a | b | L | a | b | E |
| Ex 4 | 6.23 | −0.8 | −1.43 | 7.33 | −0.79 | −2.22 | 1.35 |
| Ex 1 | 6.27 | −0.79 | −1.42 | 6.98 | −0.72 | −1.31 | 0.72 |
| Ex 2 | 6.06 | −0.8 | −1.37 | 6.55 | −0.9 | −2.08 | 0.75 |

### Surface Tension Effect on Coating Quality

Primer solutions from Example 1, 2 and 4 were prepared. The surface tension of each primer was measured using Aqua Pi Plus tensiometer by Kibron Inc. Each of the primers were coated onto a chocolate sample using the method described above, and the coating quality was evaluated for defects according to the Coating Quality Assessment above.

The primers were aged over a six week period. At selected intervals, the surface tension of each aged primer was measured and a sample of the aged primer was used to coat a chocolate sample.

The surface tension and the coating evaluations for the freshly prepared primers (initial values), and the results after the primer was aged 3 weeks and 6 weeks, are shown in Table 3.

TABLE 3
Surface Tension Stability/Coating Quality Data

| | | Surface Tension | | | | | |
|---|---|---|---|---|---|---|---|
| | | (dynes/cm) | | | Coating Quality | | |
| Type | ID | Initial | 3 weeks | 6 weeks | Initial | 3 weeks | 6 weeks |
| Comp | Ex 4 | 26 | 32 | 34 | 5 | 3 | 2 |
| Inventive | Ex 1 | 30 | 29 | 30 | 5 | 5 | 5 |
| Inventive | Ex 2 | 23 | 24.5 | 23 | 5 | 5 | 5 |

As shown in Table 4, Comparative Example 4 shows instability after 6 weeks with surface tension increased from the initial 26 dynes/cm to 34 dynes/cm, which resulted in coating quality degradation from 5 to 3 (See below for coating quality assessment). On the other hand, Inventive Examples 1 and 2 show stable surface tension value with aging and maintained coating quality during the test period.

### Printed Chocolate

Samples of Lindt white chocolate and Lindt milk chocolate were coated with the primers of example 1-4 as described above, and dried to form a coated sample, which was then printed on with edible inks using a LogoJet FSR30 printer. In each of the following examples, the coated samples were made using (A) freshly prepared primer, and (B), the primer after it was aged for two weeks.

### Inventive Example 6

Lindt white chocolate was coated with the primer of Example 1 and left to air dry overnight after which the dried sample was printed with edible ink jet inks. The printed sample was allowed to air dry for at least 1 hour before evaluation.

### Inventive Example 7

The procedure of Example 6 was repeated using Lindt milk chocolate instead of white chocolate.

### Inventive Example 8

Lindt white chocolate was coated with the primer of Example 2 and left to air dry overnight after which the dried sample was printed with edible ink jet inks. The printed sample was allowed to air dry for at least 1 hour before evaluation.

### Inventive Example 9

The procedure of Example 8 was repeated using Lindt milk chocolate instead of white chocolate.

### Comparative Example 10

Lindt white chocolate was coated with the primer of Example 3 and left to air dry overnight after which the dried sample was printed with edible ink jet inks. The printed sample was allowed to air dry for at least 1 hour before evaluation.

### Comparative Example 11

Lindt white chocolate was coated with the primer of Example 4 and left to air dry overnight after which the dried sample was printed with edible ink jet inks. The printed sample was allowed to air dry for at least 1 hour before evaluation. The results are shown in Table 4.

TABLE 4
Performance Ratings

| | Primer | | Coating | Image Quality | |
|---|---|---|---|---|---|
| | Com- | | Quality | A: Rating | B: Rating |
| Example | position | Substrate | Rating | (initial) | (2weeks) |
| Ex. 6 (Inv) | Ex. 1 | White chocolate | 5 | 5 | 5 |
| Ex. 7 (Inv) | Ex. 1 | Milk chocolate | 4 | 5 | 5 |
| Ex. 8 (Inv) | Ex. 2 | White chocolate | 5 | 5 | 5 |
| Ex. 9 (Inv) | Ex. 2 | Milk chocolate | 4 | 5 | 5 |
| Ex. 10 (Comp) | Ex. 3 | White chocolate | 1 | 1 | 1 |
| Ex. 11 (Comp) | Ex. 4 | White chocolate | 4 | 5 | 2 |

Inventive Examples 6-9 show that the primers of Examples 1 and 2 demonstrate good coating quality and printed image quality on either white or milk chocolate, both (A) when freshly prepared, and (B) after being aged for 2 weeks.

Comparative Example 10 shows that Example 3 primer coated white chocolate has poor coating quality which led to poor image quality, due to the lack of proper surfactant.

Comparative Example 11A shows that freshly made Example 4 primer coated white chocolate has good coating quality as well as good printing image quality. However, Comparative Example 11B demonstrates that, after the primer of Example 4 was aged for 2 weeks, the coated chocolate shows poor coating quality as well as poor printed image quality.

The present invention has been described in detail, including the preferred embodiments thereof. However, it will be appreciated that those skilled in the art, upon consideration of the present disclosure, may make modifications and/or improvements on this invention that fall within the scope and spirit of the invention.

What is claimed:

1. A composition comprising;
12-35 wt % one or more gums, based on the weight of the composition;
0.1 to 5 wt % in total two or more surfactants, based on the weight of the composition, comprising at least a first surfactant and a second surfactant, wherein the first surfactant comprises mono- and di glycerides of one or more C₆-C₁₂ carboxylic acids; and
60 to 85 wt % water, based on the weight of the composition;
wherein the composition is free of any opacifying agents and dries to form a transparent film; and
wherein the composition is compliant with US FDA CFR Part 21 and Europe Regulation [EC 178/2002].

2. The composition of claim 1, wherein the composition is a coating for foodstuffs.

3. The composition of claim 2, wherein the coating is a primer layer for foodstuffs, which primer is printed on with edible inks.

4. The composition of claim 1, wherein the gum is selected from the group consisting of gum arabic, guar gum, xanthan gum, agar agar powder, chia seed powder, arrowroot powder, flaxseed powder, psyllium husk and blends thereof.

5. The composition of claim 1, wherein the one or more gums comprise gum arabic.

6. The composition of claim 1, wherein the second surfactant comprises fatty acid esters of polyoxyethylene sorbitan, citric acid esters of mono-, di- and/or triglycerides, or combinations thereof.

7. The composition of claim 1, wherein the first surfactant comprises a blend of mono-, di- and triglycerides of caprylic and capric acid.

8. The composition of claim 1, wherein the second surfactant comprises polysorbate 80, polysorbate 60, polysorbate 40, polysorbate 20, or blends thereof.

9. The composition of claim 1, wherein the second surfactant comprises citric acid esters of mono- and diglycerides.

10. The composition of claim 1, containing no colorants, or opacifying agents, and which composition dries to form a transparent layer without color.

11. The composition of claim 1, containing less than 10 wt % organic solvents, and less than 2 wt % sugars, starches, modified starches, or polysaccharides other than the one or more gum, all based on the total weight of the composition.

12. The composition of claim 11, containing less than 5 wt % organic solvents, based on the total weight of the composition.

13. The composition of claim 12, containing no alcohols and no glycols.

14. The composition of claim 1, wherein the composition contains no organic solvents and no sugars, starches, modified starches, or polysaccharides other than the one or more gum.

15. A method for preparation of a decorated foodstuff comprising:
a) applying as a primer layer the composition of claim 1 to a foodstuff;
b) drying the primer layer;
c) printing one or more colored edible inks over the top of the primer layer; and
d) drying the one or more inks.

16. The method of claim 15 wherein the primer layer is applied by spray coating, nozzle coating, slot coating or inkjet printing.

17. The method of claim 15 wherein the edible inks are applied by inkjet printing.

18. The method of claim 15 comprising printing an overprint coating over the top of the inks.

19. A confectionary prepared according to the method of claim 15.

20. The confectionary of claim 19 wherein the primer layer is applied to a substrate comprising chocolate.
